(19) United States
(12) Patent Application Publication
(10) Pub. No.: US 2002/0133756 A1
(43) Pub. Date: Sep. 19, 2002

(54) System and method for providing multiple levels of fault protection in a data communication network

(75) Inventor: Sudhanshu Jain, San Jose, CA (US)

Correspondence Address: Derek J. Westberg, Stevens & Westberg LLP, Suite 201, 99 North First St., San Jose, CA, 95113, US

(73) Assignee: Maple Optical Systems, Inc., San Jose, CA (US)

(21) Appl. No.: 10/072,004

(22) Filed: Feb. 7, 2002

Related U.S. Application Data
(60) Provisional application No. 60/268,346, filed on Feb. 12, 2001.

(51) Int. Cl. G06F 11/00

(52) U.S. Cl. 714/43

(57) ABSTRACT

A system and method for providing multiple levels of fault protection in a data communication network. Fault protection criteria for each of a plurality of resources in the network is stored in each of a plurality of nodes of the network. The fault protection criteria includes indicia of a type of fault protection available to the resource. Desired fault protection criteria is determined for a label-switched path between a node of the network that is a source for data and a node of the network that is a destination for the data. A candidate resource in the network for is selected for a communication path between the source and the destination. Whether the candidate resource provides at least the desired level of fault protection is determined from the fault protection criteria. When the candidate resource provides at least the desired level of fault protection, the candidate resource is selected for the communication path. The invention provides an improved technique for managing available types of redundancy to provide a minimum specified amount of fault protection for various data flows without wasting resources, such as by providing excessive redundancy.

This application claims the benefit of U.S. Provisional Application Serial No. 60/268,346, filed Feb. 12, 2001.

The contents of U.S. patent application Ser. No. ______, filed on the same day as this application, and entitled, “SYSTEM AND METHOD FOR FAULT NOTIFICATION IN A DATA COMMUNICATION NETWORK”; and U.S. patent application Ser. No. ______, filed on the same day as this application, and entitled, “SYSTEM AND METHOD FOR FAST-REROUTING OF DATA IN A DATA COMMUNICATION NETWORK” are hereby incorporated by reference.

### FIELD OF THE INVENTION

The invention relates to the field of fault recovery in a data communication network, and more particularly, to management of fault recovery techniques in a label-switching data communication network.

### BACKGROUND OF THE INVENTION

In a label-switching network, data is transmitted through the network according to predefined paths made up of various physical components of the network. The predefined paths are referred to as label-switched paths (LSPs). Each LSP includes a specified series of movements, or hops, across communication links that connect network nodes. These nodes may include switches or routers situated along the path between the source and the destination. Typically, an LSP is established in the network between a source and destination for a data packet prior to its transmission. One example of a label-switching network is a network configured under a standard protocol developed by the Multi-Protocol Label-Switching (MPLS) Forum.

A label associated with a data packet identifies the appropriate next hop for the packet along the predefined path. At the nodes, a forwarding table (also referred to as a label-swapping table) associates incoming labels with appropriate outgoing labels. When a node receives a data packet, the forwarding table is used to look up the packet label. The corresponding entry indicates a next hop for the packet and provides the outgoing label. The router then modifies the packet by exchanging the outgoing label for the prior label before forwarding the packet along this next hop.

One problem for label-switching networks is that they tend to incorporate a large number of components, especially networks that extend over a wide area. As a result, it is inevitable that faults will occur that adversely affect data communication within the network. For example, port circuitry within a node of the network may fail in such a way as to prevent successful transmission or reception of data via the port. Or, a communication link between nodes could be damaged, preventing data from successfully traversing the link. When a fault occurs, appropriate action must be taken in order to recover from the fault and to minimize data loss. For example, if a link between nodes fails, attempts to transmit data across the link must be halted, and an alternate route must be found and put into service. If this is not done quickly, significant quantities of time-critical data may be dropped. Data may be resent from the source, but delays in re-sending the dropped data may cause additional problems.

To provide an ability to recover from a fault in a data communication network, it is generally necessary to provide some measure of redundancy. That is, when a network resource fails and is no longer available, another resource in the network must take the place of the failed resource so that operation of the network may continue.

A conventional type of redundancy is referred to as “1:1 protection.” This means that a network resource is protected by another, redundant resource that is independent of the protected network resource. For example, the protected resource and the redundant resource do not share any common elements.

Another conventional type of redundancy is referred to as “1:n protection.” This means that a group of n network resources are all protected by a single redundant resource. Thus, if any one of the protected network resources fails, then the redundant resource takes over for the failed resource. However, if more than one such protected resource fails at a time, then the redundant resource may not be capable of taking over for all of the failed resources.

Yet another conventional type of redundancy is referred to “1+1 protection.” This means that operations of a protected network resource are replicated by a redundant network resource. For example, if a data path has 1+1 protection, a second data path will simultaneously communicate a copy of the data. This type of fault protection may also be referred to as “mirroring.”

A further type of redundancy is provided by a fast re-routing technique. This means that when a link fails, the network can quickly send data along a pre-configured alternate route around the link.

Still another type of redundancy is provided by ring network topology. This means that network nodes are coupled together in a ring. Under normal operating conditions in the absence of a failure, data can be transmitted in either direction around the ring. Should a network element fail such that the ring is broken, the data can still reach its destination by traveling around the ring in a direction that avoids the break. A number of other conventional types of redundancy are known.

With the ever-increasing complexity of networks and continuous introduction of new network technologies, it is becoming increasingly difficult for network managers to specify and deploy the various fault protection techniques available for achieving appropriate levels of fault tolerance. While a conventional network may employ one or more of the aforementioned types of redundancy, the various redundancies are not generally unified into a cohesive schema for the provision of specified fault protection for various data flows. For example, a conventional router in a label-switching network can include redundant port hardware, while the network in which the router operates can include ring-type redundancy. However, because an add-drop multiplexer typically connects the router to the ring network, the multiplexer effectively isolates these two types of redundancy to different portions of the network. As such, there is no ability to integrate them or substitute one for the other. Thus, it is increasingly difficult for a network manager to determine how to configure the network so as to provide a minimum specified fault protection for various data flows without wasting resources, such as by providing excessive redundancy.

Therefore, what is needed is an improved technique for managing available types of redundancy to ensure specified fault protection for data flows in a network.

### SUMMARY OF THE INVENTION

The invention is a system and method for providing multiple levels of fault protection in a data communication network (e.g., a label-switched network). The invention provides an improved technique for managing available types of redundancy to provide a minimum specified amount of fault protection for various data flows without wasting resources, such as by providing excessive redundancy.

In one aspect of the invention, fault protection criteria for various network resources may be specified so as to provide a uniform scheme for classifying and comparing types and levels of redundancy and fault protection techniques. The criteria may include: a kind of protection which may identify a type of protected network resource; a level of protection, which may specify the type of protection provided such as 1:1, 1:n, 1+1, ring, or fast re-route; a maximum recovery time, which may specify a maximum amount of time necessary to restore traffic carried by the protected resource; and a quality of backup path, which may specify characteristics of a back-up path.

Indicia of the fault protection criteria may then be transmitted throughout the network. For example, each network element (e.g., a node) may communicate the protection criteria provided by its associated network resources to the other network elements in the network.

The advertised fault protection criteria of the network resources may then be used when a network element sets up a communication path to send data. For example, in addition to the advertised protection criteria, a network element setting up a communication path may also have protection requirements for the path. For example, a sender of data (e.g., an application program or a user) may specify the protection criteria to be utilized for sending the data. The network element setting up the path may then compare the criteria received from the other network elements to the requirements for the path to determine which resources may be used to form the path (and its secondary backup path) to meet the protection requirements specified for the path. For example, if a network resource to be used by the path is already protected by a level specified for the path, no additional protection is required for that network resource. However, if a network resource to be used by the path does not have sufficient protection, additional protection may need to be added for that resource or an alternate resource selected that does have sufficient fault protection.

In accordance with another aspect of the invention, a method of, and a system for, managing multiple levels of fault protection in a data communication network are provided. Fault protection criteria for each of a plurality of resources in the network is stored in each of a plurality of nodes of the network. The fault protection criteria includes indicia of a type of fault protection available to the resource. Desired fault protection criteria is determined for a communication path between a node of the network that is a source for data and a node of the network that is a destination for the data. A candidate resource in the network is selected. Whether the candidate resource provides at least the desired level of fault protection is determined from the fault protection criteria. When the candidate resource provides at least the desired level of fault protection, the candidate resource is selected for the data communication path.

### BRIEF DESCRIPTION OF THE DRAWINGS

FIG. 1 illustrates a diagram of a network in which the present invention may be implemented;

FIG. 2 illustrates a packet label that can be used for packet label switching in the network of FIG. 1;

FIG. 3 illustrates a block schematic diagram of a router in accordance with the present invention;

FIG. 4 illustrates a flow diagram for fault notification in accordance with the present invention;

FIG. 5 illustrates a shared risk link group (SRLG) identifier in accordance with the present invention;

FIGS. 6A-B illustrate flow diagrams for fast re-routing of data in accordance with the present invention;

FIG. 7 illustrates the network of FIG. 1 including fast re-route label-switched paths in accordance with the present invention;

FIG. 8 illustrates a type-length-value for supporting fast re-routing in accordance with the present invention; and

FIGS. 9A-B illustrate flow diagrams for managing multiple levels of fault protection in accordance with the present invention.

### DETAILED DESCRIPTION OF A PREFERRED EMBODIMENT

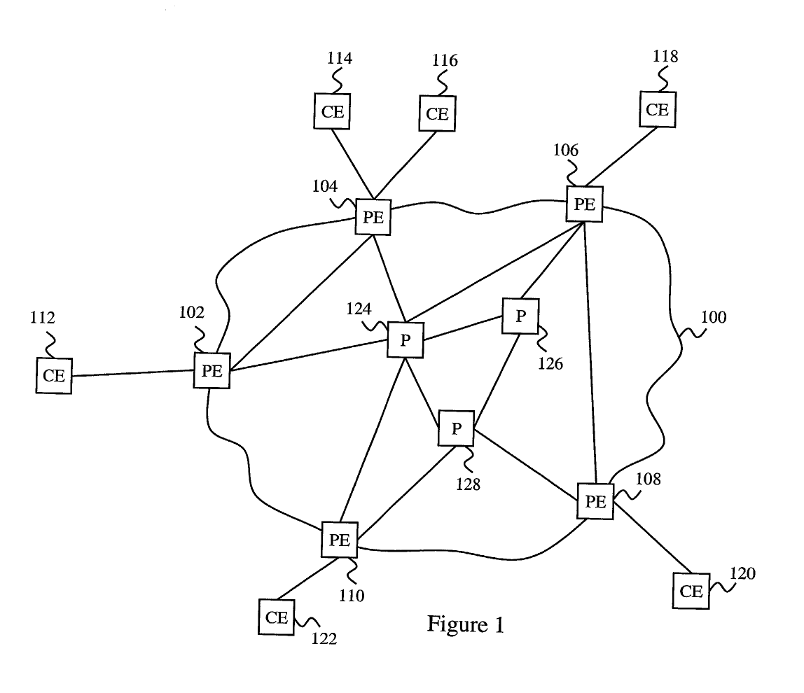

FIG. 1 illustrates a block schematic diagram of a network domain (also referred to as a network “cloud”) 100 in which the present invention may be implemented. The network 100 includes edge equipment (also referred to as provider equipment or, simply, “PE”) 102, 104, 106, 108, 110 located at the periphery of the domain 100. Edge equipment 102-110 may each communicate with corresponding ones of external equipment (also referred to as customer equipment or, simply, “CE”) 112, 114, 116, 118, 120 and 122 and may also communicate with each other via network links. As shown in FIG. 1, for example, edge equipment 102 is coupled to external equipment 112 and to edge equipment 104. Edge equipment 104 is also coupled to external equipment 114 and 116. In addition, edge equipment 106 is coupled to external equipment 118 and to edge equipment 108, while edge equipment 108 is also coupled to external equipment 120. And, edge equipment 110 is coupled to external equipment 122.

The external equipment 112-122 may include equipment of various local area networks (LANs) that operate in accordance with any of a variety of network communication protocols, topologies and standards (e.g., PPP, Frame Relay, Ethernet, ATM, TCP/IP, token ring, etc.). Edge equipment 102-110 provide an interface between the various protocols utilized by the external equipment 112-122 and protocols utilized within the domain 100. In one embodiment, communication among network entities within the domain 100 is performed over fiber-optic links and accordance with a high-bandwidth capable protocol, such as Synchronous Optical NETwork (SONET) or Gigabit Ethernet (1 Gigabit or 10 Gigabit). In addition, a unified, label-switching (sometimes referred to as “label-swapping”) protocol, for example, multi-protocol label switching (MPLS), is preferably utilized for directing data throughout the network 100.

Internal to the network domain 100 are a number of network switches (also referred to as provider switches, provider routers or, simply, “P”) 124, 126 and 128. The switches 124-128 serve to relay and route data traffic among the edge equipment 102-110 and other switches. Accordingly, the switches 124-128 may each include a plurality of ports, each of which may be coupled via network links to another one of the switches 124-128 or to the edge equipment 102-110. As shown in FIG. 1, for example, the switches 124-128 are coupled to each other. In addition, the switch 124 is coupled to edge equipment 102, 104, 106 and 110. The switch 126 is coupled to edge equipment 106, while the switch 128 is coupled to edge equipment 108 and 110. Note that the edge equipment 102-110 and switches 124-128 may be referred to simply as network “nodes.”

It will be apparent that the particular topology of the network 100 and external equipment 112-122 illustrated in FIG. 1 is exemplary and that other topologies may be utilized. For example, more or fewer external equipment, edge equipment or switches may be provided. In addition, the elements of FIG. 1 may be interconnected in various different ways.

The scale of the network 100 may vary as well. For example, the various elements of FIG. 1 may be located within a few feet or each other or may be located hundreds of miles apart. Advantages of the invention, however, may be best exploited in a network having a scale on the order of hundreds of miles. This is because the network 100 may facilitate communications among customer equipment that uses various different protocols and over great distances. For example, a first entity may utilize the network 100 to communicate among: a first facility located in San Jose, Calif.; a second facility located in Austin, Tex.; and third facility located in Chicago, Ill. A second entity may utilize the same network 100 to communicate between a headquarters located in Buffalo, N.Y. and a supplier located in Salt Lake City, Utah. Further, these entities may use various different network equipment and protocols. Note that long-haul links may also be included in the network 100 to facilitate, for example, international communications.

The network 100 may be configured to provide allocated bandwidth to different user entities. For example, the first entity mentioned above may need to communicate a greater amount of data between its facilities than the second entity mentioned above. In which case, the first entity may purchase from a service provider a greater bandwidth allocation than the second entity. For example, bandwidth may be allocated to the user entity by assigning various channels (e.g., OC-3, OC-12, OC-48 or OC-192 channels) within SONET STS-1 frames that are communicated among the various locations in the network 100 of the user entity's facilities.

Generally, a packet transmitted by a piece of external equipment 112-122 (FIG. 1) is received by one of the edge equipment 102-110 (FIG. 1) of the network 100. For example, a data packet may be transmitted from customer equipment 112 to edge equipment 102. This packet may be accordance with any of a number of different network protocols, such as Ethernet, ATM, TCP/IP, etc.

Once the packet is received, the packet may be de-capsulated from a protocol used to transmit the packet. For example, a packet received from external equipment 112 may have been encapsulated according to Ethernet, ATM or TCP/IP prior to transmission to the edge equipment 102.

Generally, edge equipment 112-120 that receives a packet from external equipment will not be a destination for the data. Rather, in such a situation, the packet may be delivered to its destination node by the external equipment without requiring services of the network 100. In which case, the packet may be filtered by the edge equipment 112-120. Assuming that one or more hops are required, the network equipment (e.g., edge equipment 102) determines an appropriate label switched path (LSP) for the packet that will route the packet to its intended recipient. For this purpose, a number of LSPs may have previously been set up in the network 100. Alternately, a new LSP may be set up in the state 210. The LSP may be selected based in part upon the intended recipient for the packet. A label may then be appended to the packet to identify a next hop in the LSP.

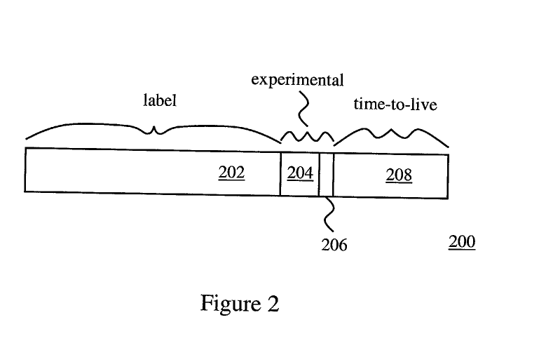

FIG. 2 illustrates a packet label header 200 that can be appended to data packets for label switching in the network of FIG. 1. The header 200 preferably complies with the MPLS standard for compatibility with other MPLS-configured equipment. However, the header 200 may include modifications that depart from the MPLS standard. As shown in FIG. 2, the header 200 includes a label 202 that may identify a next hop along an LSP. In addition, the header 200 preferably includes a priority value 204 to indicate a relative priority for the associated data packet so that packet scheduling may be performed. As the packet traverses the network 100, additional labels may be added or removed in a layered fashion. Thus, the header 200 may include a last label stack flag 206 (also known as an “S” bit) to indicate whether the header 200 is the last label in a layered stack of labels appended to a packet or whether one or more other headers are beneath the header 200 in the stack. In one embodiment, the priority 204 and last label flag 206 are located in a field designated by the MPLS standard as “experimental.”

Further, the header 200 may include a time-to-live (TTL) value 208 for the label 202. For example, the TTL value 208 may set to an initial value that is decremented each time the packet traverses a next hop in the network. When the TTL value 208 reaches “1” or zero, this indicates that the packet should not be forwarded any longer. Thus, the TTL value 208 can be used to prevent packets from repeatedly traversing any loops that may occur in the network 100.

The labeled packet may then be further converted into a format that is suitable for transmission via the links of the network 100. For example, the packet may be encapsulated into a data frame structure, such as a SONET frame or a Gigabit Ethernet frame. Portions (e.g., channels) of each frame are preferably reserved for various LSPs in the network 100. Thus, various LSPs can be provided in the network 100 to user entities, each with an allocated amount of bandwidth.

Thus, the data received by the network equipment (e.g., edge equipment 102) may be inserted into an appropriate allocated channel in the frame along with its header 200 (FIG. 2). The packet is communicated within the frame along a next hop of the appropriate LSP in the network 100. For example, the frame may be transmitted from the edge equipment 102 (FIG. 1) to the switch 124 (FIG. 1).

The packet may then be received by equipment of the network 100 such as one of the switches 124-128. For example, the packet may be received by switch 124 (FIG. 1) from edge equipment 102 (FIG. 1). The data portion of the packet may be decapsulated from the protocol (e.g., SONET) used for links within the network 100 (FIG. 1). Thus, the packet and its label header may be retrieved from the frame. The equipment (e.g., the switch 124) may swap a present label 202 (FIG. 2) with a label for the next hop in the network 100. Alternately, a label may be added, depending upon the TTL value 208 (FIG. 2) for the label header 200 (FIG. 2).

This process of passing the data from node to node repeats until the equipment of the network 100 that receives the packet is a destination for the data. When the data has reached a destination in the network 100 (FIG. 1) such that no further hops are required, the label header 200 (FIG. 2) may be removed. Then, packet may be encapsulated into a protocol appropriate for delivery to its destination. For example, if the destination expects the packet to have Ethernet, ATM or TCP/IP encapsulation, the appropriate encapsulation may be added. The packet or other data may then be forwarded to external equipment in its original format. For example, assuming that the packet sent by customer equipment 102 was intended for customer equipment 118, the edge equipment 106 may remove the label header from the packet, encapsulate it appropriately and forward the packet to the customer equipment 118.

Thus, a network system has been described in which label switching (e.g., MPLS protocol) may be used in conjunction with a link protocol (e.g., SONET) in a novel manner to allow disparate network equipment (e.g., PPP, Frame Relay, Ethernet, ATM, TCP/IP, token ring, etc.) the ability to communicate via a shared network resources (e.g., the equipment and links of the network 100 of FIG. 1).

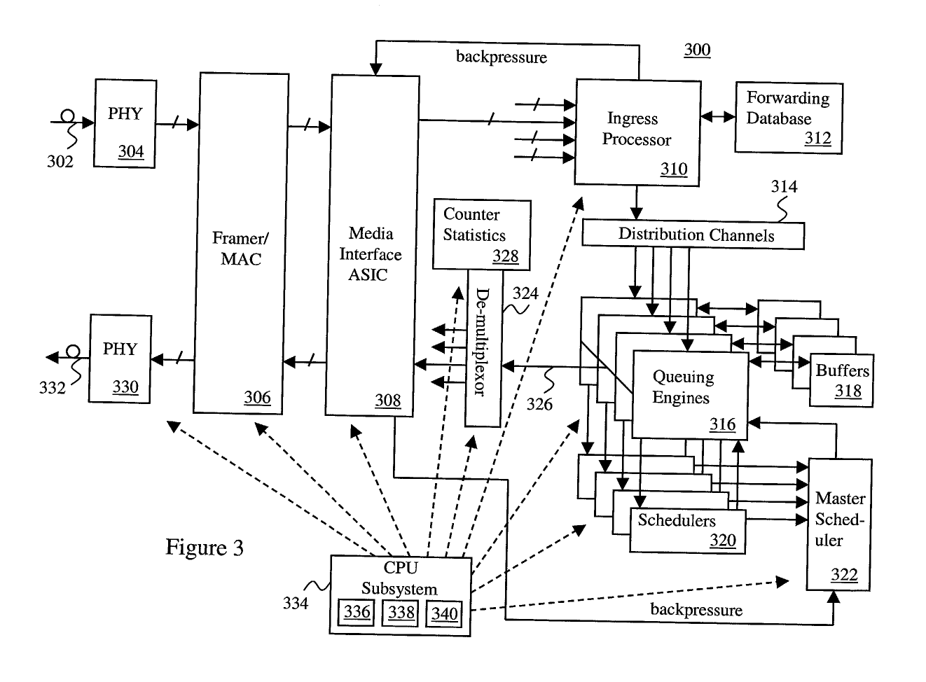

FIG. 3 illustrates a block schematic diagram of a switch or router 300 that may be utilized as any of the switches 124, 126 and 128 or edge equipment 102-110 of FIG. 1. Referring to FIG. 3, the switch 300 includes an input port connected to a transmission media 302. For illustration purposes, only one input port (and one output port) is shown in FIG. 3, though the switch 300 includes multiple pairs of ports. Each input port may include an input path through a physical layer device (PHY) 304, a framer/media access control (MAC) device 306 and a media interface (I/F) device 308.

The PHY 304 may provide an interface directly to the transmission media 302 (e.g., the network links of FIG. 1). The PHY 304 may also perform other functions, such as serial-to-parallel digital signal conversion, synchronization, non-return to zero (NRZI) decoding, Manchester decoding, 8B/10B decoding, signal integrity verification and so forth. The specific functions performed by the PHY 304 may depend upon the encoding scheme utilized for data transmission. For example, the PHY 604 may provide an optical interface for optical links within the domain 100 (FIG. 1) or may provide an electrical interface for links to equipment external to the domain 100.

The framer device 306 may convert data frames received via the media 302 in a first format, such as SONET or Gigabit Ethernet, into another format suitable for further processing by the switch 300. For example, the framer device 306 may separate and decapsulate individual transmission channels from a SONET frame and then may identify a packet type for packets received in each of the channels. The packet type may be included in the packet where its position may be identified by the framer device 306 relative to a start-of-frame flag received from the PHY 304. Examples of packet types include: Ether-type (V₂); Institute of Electrical and Electronics Engineers (IEEE) 802.3 Standard; VLAN/Ether-Type or VLAN/802.3. It will be apparent that other packet types may be identified. In addition, the data need not be in accordance with a packetized protocol. For example, the data may be a continuous stream.

The framer device 306 may be coupled to the media I/F device 308. The I/F device 308 may be implemented as an application-specific integrated circuit (ASIC). The I/F device 308 receives the packet and the packet type from the framer device 306 and uses the type information to extract a destination key (e.g., a label switch path to the destination node or other destination indicator) from the packet. The destination key may be located in the packet in a position that varies depending upon the packet type. For example, based upon the packet type, the I/F device may parse the header of an Ethernet packet to extract the MAC destination address.

An ingress processor 310 may be coupled to the input port via the media I/F device 308. Additional ingress processors (not shown) may be coupled to each of the other input ports of the switch 300, each port having an associated media I/F device, a framer device and a PHY. Alternately, the ingress processor 310 may be coupled to all of the other input ports. The ingress processor 310 controls reception of data packets. Memory 312, such as a content addressable memory (CAM) and/or a random access memory (RAM), may be coupled to the ingress processor 310. The memory 312 preferably functions primarily as a forwarding database which may be utilized by the ingress processor 310 to perform look-up operations, for example, to determine which are appropriate output ports for each packet or to determine which is an appropriate label for a packet. The memory 312 may also be utilized to store configuration information and software programs for controlling operation of the ingress processor 310.

The ingress processor 310 may apply backpressure to the I/F device 608 to prevent heavy incoming data traffic from overloading the switch 300. For example, if Ethernet packets are being received from the media 302, the framer device 306 may instruct the PHY 304 to send a backpressure signal via the media 302.

Distribution channels 314 may be coupled to the input ports via the ingress processor 310 and to a plurality of queuing engines 316. In one embodiment, one queuing engine is provided for each pair of an input port and an output port for the switch 300, in which case, one ingress processor may also be provided for the input/output port pair. Note that each input/output pair may also be referred to as a single port or a single input/output port. The distribution channels 314 preferably provide direct connections from each input port to multiple queuing engines 316 such that a received packet may be simultaneously distributed to the multiple queuing engines 316 and, thus, to the corresponding output ports, via the channels 314.

Each of the queuing engines 316 is also associated with one of a plurality of buffers 318. Because the switch 300 preferably includes sixteen input/output ports for each of several printed circuit boards referred to as “slot cards,” each slot card preferably includes sixteen queuing engines 316 and sixteen buffers 318. In addition, each switch 300 preferably includes up to sixteen slot cards. Thus, the number of queuing engines 316 preferably corresponds to the number of input/output ports and each queuing engine 316 has an associated buffer 318. It will be apparent, however, that other numbers can be selected and that less than all of the ports of a switch 300 may be used in a particular configuration of the network 100 (FIG. 1).

As mentioned, packets are passed from the ingress processor 310 to the queuing engines 316 via distribution channels 314. The packets are then stored in buffers 318 while awaiting retransmission by the switch 300. For example, a packet received at one input port may be stored in any one or more of the buffers 318. As such, the packet may then be available for re-transmission via any one or more of the output ports of the switch 300. This feature allows packets from various different input ports to be simultaneously directed through the switch 300 to appropriate output ports in a non-blocking manner in which packets being directed through the switch 300 do not impede each other's progress.

For scheduling transmission of packets stored in the buffers 318, each queuing engine 316 has an associated scheduler 320. The scheduler 320 may be implemented as an integrated circuit chip. Preferably, the queuing engines 316 and schedulers 320 are provided two per integrated circuit chip. For example, each of eight scheduler chips may include two schedulers. Accordingly, assuming there are sixteen queuing engines 316 per slot card, then sixteen schedulers 320 are preferably provided.

Each scheduler 320 may prioritize data packets by selecting the most eligible packet stored in its associated buffer 318. In addition, a master scheduler 322, which may be implemented as a separate integrated circuit chip, may be coupled to all of the schedulers 320 for prioritizing transmission from among the then-current highest priority packets from all of the schedulers 320. Accordingly, the switch 300 preferably utilizes a hierarchy of schedulers with the master scheduler 322 occupying the highest position in the hierarchy and the schedulers 320 occupying lower positions. This is useful because the scheduling tasks may be distributed among the hierarchy of scheduler chips to efficiently handle a complex hierarchical priority scheme.

For transmitting the packets, the queuing engines 316 are coupled to the output ports of the switch 300 via demultiplexor 324. The demultiplexor 324 routes data packets from a bus 326, shared by all of the queuing engines 316, to the appropriate output port for the packet. Counters 328 for gathering statistics regarding packets routed through the switch 300 may be coupled to the demultiplexor 324.

Each output port may include an output path through a media I/F device, framer device and PHY. For example, an output port for the input/output pair illustrated in FIG. 3 may include the media I/F device 308, the framer device 306 and the input PHY 304.

In the output path, the I/F device 308, the framer 306 and an output PHY 330 essentially reverse the respective operations performed by the corresponding devices in the input path. For example, the I/F device 308 may add a link-layer encapsulation header to outgoing packets. In addition, the media I/F device 308 may apply backpressure to the master scheduler 322, if needed. The framer 306 may then convert packet data from a format processed by the switch 300 into an appropriate format for transmission via the network 100 (FIG. 1). For example, the framer device 306 may combine individual data transmission channels into a SONET frame. The PHY 330 may perform parallel to serial conversion and appropriate encoding on the data frame prior to transmission via media 332. For example, the PHY 330 may perform NRZI encoding, Manchester encoding or 8B/10B decoding and so forth. The PHY 330 may also append an error correction code, such as a checksum, to packet data for verifying integrity of the data upon reception by another element of the network 100 (FIG. 1).

A central processing unit (CPU) subsystem 334 included in the switch 300 provides overall control and configuration functions for the switch 300. For example, the subsystem 334 may configure the switch 300 for handling different communication protocols and for distributed network management purposes. In one embodiment, each switch 300 includes a fault manager module 336, a protection module 338 and a network management module 340. For example, the modules 336-340 may be included in the CPU subsystem 334 and may be implemented by software programs that control a general-purpose processor of the subsystem 334.

An aspect of the invention is a system and method for fault notification in a label-switching network. In accordance with the invention, notification of each fault occurring in the network is quickly and efficiently propagated throughout the network so that appropriate action can be taken to recover from the fault.

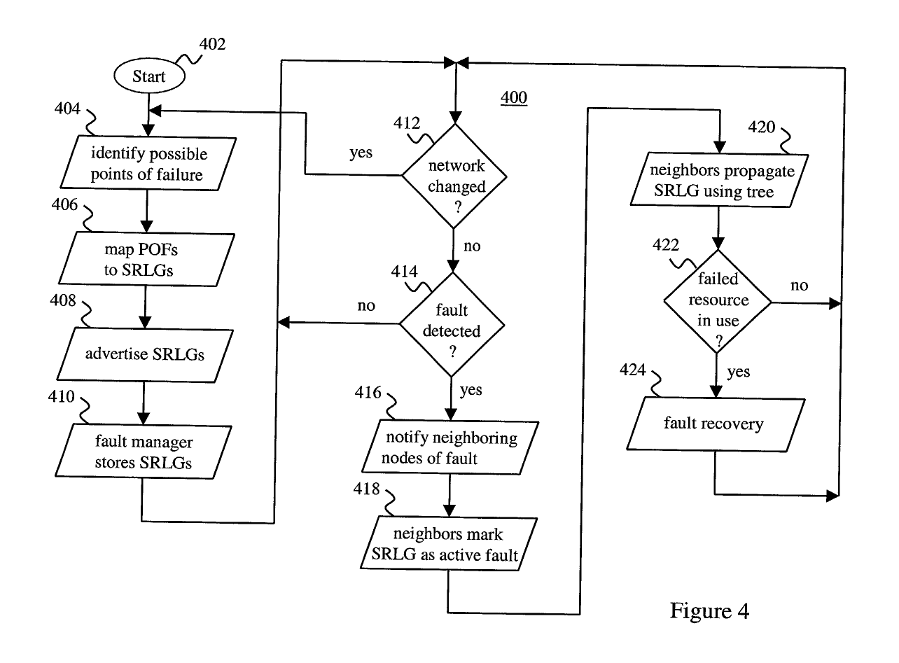

FIG. 4 illustrates a flow diagram 400 for fault notification in accordance with the present invention. As explained in more detail herein, the flow diagram 400 may be implemented by the network 100 illustrated in FIG. 1 and by elements of the network 100, such as the router 300 illustrated in FIG. 3. Program flow begins in a start state 402. From the state 402, program flow moves to a state 404 in which possible points of failure in the network may be identified. For example, each router 300 (FIG. 3) in the network 100 (FIG. 1) may include a number of card slots that accept port circuitry (e.g., queuing engines 318, buffers 320 and/or schedulers 322 of FIG. 3). Thus, a point of failure may be the circuitry or connector associated with any of the card slots. In one embodiment, the router 300 includes sixteen card slots, one for each of sixteen port circuitry cards (the port circuitry cards are also referred to as “slot cards”). In addition, each router 300 may be coupled to a number of network links. Thus, a point of failure may be any of the network links. In one embodiment, each port circuitry card includes circuitry for sixteen input/output port pairs. Thus, in the case of a router having one two-way network link for each input/output port, the router may be coupled to up to 1024 network links. Note, however, that there need not be a one-to-one correspondence of links to input/output port pairs. For example, multiple links or input/output port pairs may provide redundancy for fault tolerance purposes.

From the state 404, program flow moves to a state 406. In the state 406, each possible point of failure (POF) may be represented as a shared resource link group (SRLG). An SRLG corresponds to a group of network components that commonly uses a particular element of the network for which the SRLG is established. For example, an SRLG may be established for a network switch or router that is used by other switches and routers in the network for sending and receiving messages. Thus, the SRLG provides indicia of a possible point of failure.

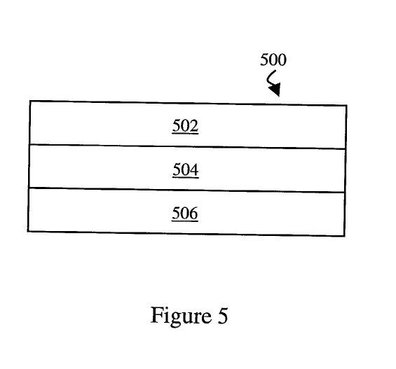

FIG. 5 illustrates an SRLG identifier 500 in accordance with the present invention. The SRLG 500 may be communicated in the network 100 (FIG. 1) by placing the SRLG 500 into the payload of a label-switched packet. In one embodiment, each SRLG 500 includes three fields 502, 504, 506. A first field 502 may identify a component of the network such as a router (e.g., one of the network elements 102-110 or 124-128 of FIG. 1) with which the POF is associated. The second field 504 may identify a sub-element of the component identified in the first field 502, such as a card slot associated with the POF. This slot is part of the router indicated by the first field 502. In one embodiment, a second field 504 includes a mask having a number of bits that corresponds to the number of card slots of the router (e.g., sixteen). A logical “one” in a particular bit-position may identify the corresponding slot. A third field 506 may include an identification of a logical network link or physical network link coupled to the router and associated with the POF. A logical network link may differ from a physical link in that a logical link may comprise multiple physical links. Further, the multiple physical links of the logical link may each be associated with a different slot of the router. In which case, the second field 504 of the SRLG 500 may include multiple logical “ones.”Thus, in the state 406, each switch or router 300 may map each of its own associated POFs to an appropriate SRLG 500. Once the possible points of failure have been identified and an SRLG formed for each, program flow then moves to a state 408. In the state 408, the router may inform other routers in the network of its SRLGs. For example, the SRLGs may be propagated to all other routers using an interior gateway protocol (IGP) such as open-shortest path first (OSPF). Alternately, the point of failure and SRLG information may originate from another area of the network or from outside the network. In either case, each router is eventually informed of the possible points of failure that may occur throughout the network.

From the state 408, program flow moves to a state 410. In the state 410, each router may store the SRLGs that relate to its own possible points of failure and those that relate to possible points of failure in other portions of the network. For example, each router may store only the SRLGs that correspond to resources within the network that particular router is using to send data (e.g., those resources being used by LSPs set up by the router). The SRLGs are preferably stored under control of the fault manager 336 (FIG. 3) of each router, such as in a table in a local memory of the CPU subsystem 334 (FIG. 3). Thus, once the SRLGs are propagated to all of the routers, each of the routers preferably stores an identification of all of the possible points of failure for the network that could adversely affect the activities of the router.

From the state 410, program flow moves to a state 412 where a determination may be made as to whether the topology of the network 100 (FIG. 1) has changed. For example, as resources such as routers and links are added or removed from the network, the possible points of failure may also change. Thus, if such a change has occurred, the affected routers will detect this such as by receiving network status notifications. In which case, program flow returns to the state 404 where possible points of failure are again identified, mapped to SRLGs (state 406); advertised (state 408) and stored (state 410). Note that program flow may return to the state 404 from any portion of the flow diagram, as necessary. Further, only those POFs that are affected by the change need to be re-advertised.

Assuming, however, that no changes have occurred, program flow moves from the state 412 to a state 414. In the state 414, a determination is made as to whether a fault has occurred. If not, program flow may return to the state 412 until a fault occurs.

When a fault does occur, program flow moves to a state 416. The fault will generally be detected by one of the nodes of the network 100 (FIG. 1). For example, the internal circuitry of a router (e.g., nodes 124, 126 or 128 of FIG. 1) may detect a failure associated with a particular one of its slots. Alternately, a router may detect a failure of an associated link such as by an absence or discontinuance of data received from the link or by a link layer mechanism. Other fault detection techniques may be implemented.

In the state 416, the node that detects the failure sends a notification of the failure to its neighbors. For this purpose, all the network interfaces of a particular node may be part of a special MPLS multicast group. The notification preferably includes the SRLG that corresponds to the particular failure that occurred. A protocol used for sending regular data traffic among the nodes of the network, such as by label-switched packets, may also be utilized for transmitting the notification such that it can be carried reliably and efficiently, with minimal delay. For example, the fault notification may be transmitted within an MPLS network using IGP. A link-layer header and an appropriate label 200 (FIG. 2) may be appended to the SRLG prior to sending. In addition, the fault notification packet may be encapsulated using an IP header for handling at higher network layers. If the fault results in multiple points of failure, then sending of multiple SRLGs may be originated in the state 416, as appropriate.

In one configuration, if a single fault affects multiple components, or otherwise results in multiple points of failure, then sending of multiple SRLGs may be originated as appropriate. Using this configuration, fault notifications may be sent out more quickly than if one single notification were to be sent out following a fault. Also, in the case of multiple point failures, nodes may be islanded off or partially secluded, blocking them from receiving certain fault notifications. Thus, the transmission of multiple SRLGs originated from multiple different locations could allow such a node or other component to receive the notifications.

Program flow then moves from the state 416 to a state 418. In the state 418, the neighboring nodes may receive the fault notification and take notice of the fault. For example, each router may pass the SRLG 500 (FIG. 5) received in the fault notification to its fault manager 336 (FIG. 3), and store an indication that the SRLG 500 received in the fault notification as an active failure in a respective local memory of the CPU subsystem 334 (FIG. 3).

Then, in a state 420, the neighboring nodes may propagate the notification to other nodes in the network. Thus, in a short time, each router in the network is notified of the failure and records the failed network resource identified by the SRLG 500 (FIG. 5) contained in the original failure notification.

To propagate the failure notification throughout the network in an efficient manner, each node (e.g., routers 124, 126, 128 of FIG. 1) preferably has a number of pre-configured multi-cast trees. These multi-cast trees may be stored in the label-swapping table (e.g., in the forwarding database 312) for the router. Thus, when the router becomes aware of a fault, it sends a notification via a multi-cast tree that specifies paths to all the other nodes in the network. When a node receives a fault notification from a particular one of its interfaces (e.g., one of its ports) it may use the label 200 (FIG. 2) from the notification, along with the identification of the interface to look up the appropriate next-hop(s) in its label-swapping table. A time to live (TTL) value 206 (FIG. 2) in a MPLS shim header of the fault notification may be set to an appropriate value based on then-current routing topology. Each node that receives the notification may decrement the TTL 206 and forward the fault notification to all its interfaces except the interface via which the notification was received. The nodes may also forward the fault notification to each of their fault handling modules 336 (FIG. 3).

The label (e.g., the label 202 of FIG. 2) used for a fault notification may be referred to as a “fault information label” (FIL). The data packet labeled with a FIL may contain information related to the faulty component including the component's SRLG and other information. Accordingly, the information contained within the FIL may be utilized along with associated payload data to allow other network components to identify a fault. In one embodiment, the information is used by each network component, such as a node, to determine whether the fault is likely to affect the operations of the node.

In an embodiment of the invention, the same label may be used for all of the fault notifications transmitted within the network 100 (FIG. 1). Thus, the label 202 appended to the notification may be a network-wide label. The FIL may be negotiated between the routers of the network so as to ensure that the FIL is unique. Thus, each router can determine from the FIL alone that the payload of the packet is the SRLG for a network component that has failed. Alternately, each node may advertise its own individualized label such as by using IGP.

Based on the locally configured labels and the labels learned through IGP, each node configures a local multicast distribution tree for propagating fault notifications. More particularly, each node may determine which interfaces to neighbors are fault capable. The node may then advertise its FIL to its adjacent nodes. The adjacent nodes each add the FIL its multicast distribution tree. Thus, the trees set-up label switched paths among the nodes. These LSPs are then ready to be used for propagating fault notifications when a notification is received by a node from an adjacent node. When labels are learned or lost in response to changes in the network, the trees may be changed. The local fault manager 336 (FIG. 3) module may also be part of each tree.

Once the nodes of the network 100 (FIG. 1) become aware of the fault by receiving a fault notification, program flow moves to a state 422. In the state 422, a determination may be made as to whether the failed resource is in use. For example, each node (e.g., 102-110 and 124-128) determines whether the SRLG received in the fault notification matches any network resources being used by the node. Assuming that the resource is in use, then program flow moves to a state 424 in which appropriate steps may be taken, as necessary, to recover from the fault. For example, a router that had been transmitting data via a network link that has since been declared as failed may then re-route the data around the failed link. Once recovery is complete, program flow may return to the state 412. However, a router that is not utilizing a network component that has been declared as failed need not take any recovery steps. Thus, if the failed network resource is not in use, program flow may return directly to the state 412 from the state 422.

Thus, the invention augments conventional MPLS to provide fault notification, which can be used by network elements to take required recovery action.

Another aspect of the invention is a system and method for fast re-routing of data in a label-switching network. In accordance with the invention, alternate label switched paths (LSPs) are defined for bypassing entire network nodes, rather than merely bypassing individual network links. As such, the protection LSPs allow data to be re-routed so as to avoid failed network nodes as well as failed network links.

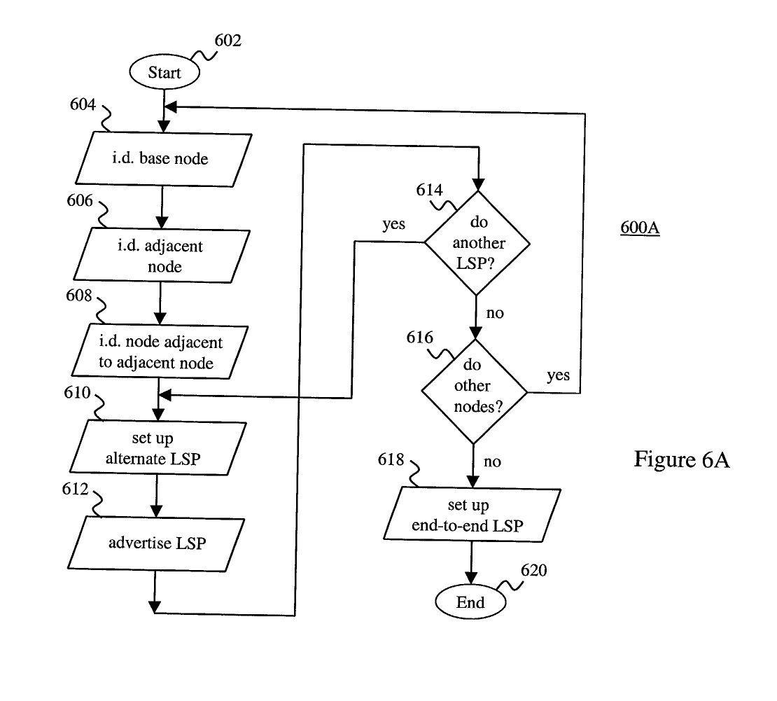

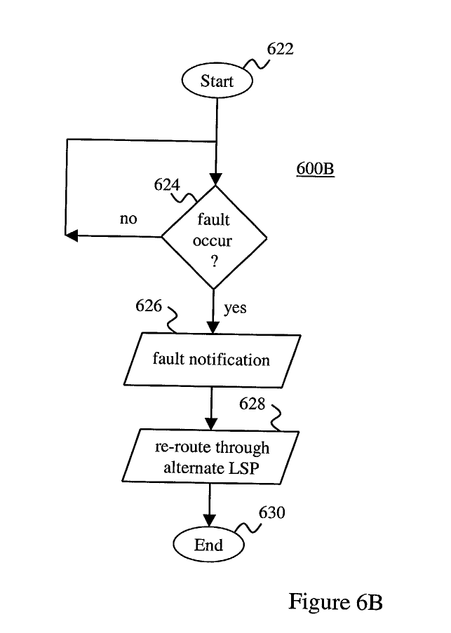

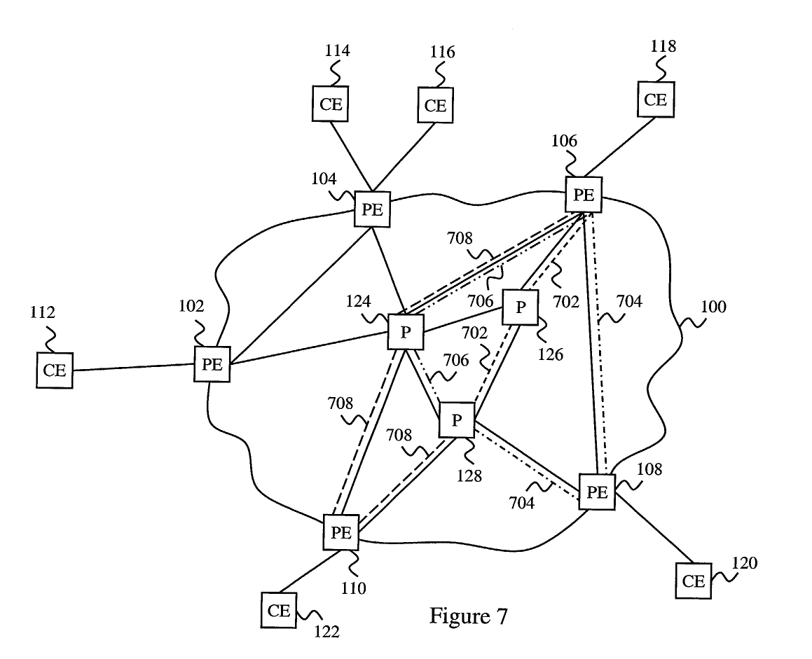

FIGS. 6A-B illustrate flow diagrams 600A-B for fast re-routing of data in accordance with the present invention. As explained in more detail herein, the flow diagrams 600A-B may be implemented by the network 100 illustrated in FIG. 1 and by elements of the network 100, such as the router 300 illustrated in FIG. 3. FIG. 7 illustrates the network 100 of FIG. 1 including fast re-route label-switched paths (LSPs) 702-708 in accordance with the present invention.

Initially, one or more protection LSPs is defined. Each of these LSPs extends from a node in the network to another node that is at least two hops away, though two is the preferred number of hops. Thus, the protection LSP provides an alternate route between a first node and second node and avoids a third node that is between the first and second node. In addition, one or more protection LSPs may also be defined for the reverse path, i.e. for data traveling from the second node to the first node.

Referring to FIG. 6, program flow begins in a start state 602. From the state 602, program flow moves to a state 604. In the state 604, a node (referred to herein as a “base” node) is identified. Then, program flow moves to a state 606 in which a node adjacent to the base node is identified. In other words, another node (referred to herein as an “intermediate” node) is identified that is one hop away from the base node. For example, referring to FIG. 7, assuming that the node 128 is acting as the base node, the node 124 may be identified in the state 606 as being one hop away.

Next, program flow moves to a state 608. In the state 608, a node (referred to herein as an “end” node) may be identified that is adjacent to (i.e. one hop away from) the intermediate node identified in the state 606. In other words, the end node identified in the state 608 is two hops away from the base node identified in the state 604. Thus, referring again to FIG. 7, the node 106, which is two hops away from the base node 128, may be identified in the state 608. A distributed network manager may perform the steps of identifying the nodes in the states 604-608. For example, the distributed network manager may be implemented by network manager software modules 340 (FIG. 3) executed by the CPU subsystems 334 (FIG. 3) of nodes of the network 100 (FIG. 1).

Then, program flow moves to a state 610. In the state 610, a label switched path (LSP) may be set up that has its origin at the base node (e.g., node 128) and terminates at the end node (e.g., node 106). Preferably, this LSP does not pass through the intermediate node (e.g., node 124). Accordingly, this LSP may be illustrated in FIG. 7 by the LSP 702. As can be seen from FIG. 7, the LSP 702 provides an alternate path from the node 128 to the node 106 that does not include the node through which the adjacency was learned (i.e. the node 124). Rather, the path 702 passes through the node 126. As such, this alternate path 702 would be suitable for use in the event the node 124 or a connected link experiences a fault, regardless of whether it is a partial failure or a complete failure.

The LSP 702 may be set up in the state 610 under control of the distributed network manager using an Interior Gateway Protocol (IGP) domain along with Resource ReSerVation Protocol (RSVP) or Label Distribution Protocol (LDP).

From the state 610, program flow moves to a state 612. In the state 612, the LSP set up in the state 610 (e.g., LSP 702 of FIG. 7) may be advertised to other nodes of the network 100 (FIG. 7). For example, availability of the LSP 702 may be advertised within the network 100 using IGP to send protocol-opaque Link State Attributes (LSAs) having indicia of the protection LSP. For example, this protection LSP 702 may be advertised as a link property for LSPs that use the bypassed node 124 or connected links. This information may be stored by each node and used when a node re-routes data around such a network fault to provide fast re-route protection for the path.

More than one such LSP may be set up for the same remote node. Having multiple protection LSPs for the same pair of nodes may be advantageous such as for increased fault tolerance and/or load balancing. Thus, program flow may move from the state 612 to a state 614 where a determination is made as to whether another alternate LSP should be set up.

Assuming one or more additional protection LSPs are to be set up, program flow returns to the state 610. In the state 610, another alternate path may be set up. For example, this alternate path may be illustrated in FIG. 7 by the path 704. As can be seen from FIG. 7, the path 704 also extends between nodes 128 and 106 and does not pass through the node 124. Rather, the path 704 passes through the node 108. Then, in the state 612, the path 704 may be advertised throughout the network 100.

Once the desired alternate paths have been set up between the base node identified in the state 604 and the end node identified in the state 608, and advertised to the other nodes in the state 612, program flow may move from the state 614 to a state 616. In the state 616, a determination is made as to whether one or more alternate LSPs should be set up using other base, intermediate and/or end nodes. The determinations made in the states 614 and 616 may be made under control of the distributed network manager that may be implemented by the network manager software module 340 (FIG. 3) of the network nodes.

Assuming additional protection paths are to be set up, program flow returns to the state 604 and the process described above may be repeated for other nodes. For example, the node 128 may again be selected as the base node, the node 126 may be selected as the intermediate node and the node 106 may again be selected as the end node. Then, an alternate LSP 706 may be set up which passes through the node 124. Another alternate LSP 708 may be set up which passes through the nodes 110 and 124. Further, other protection LSPs may be set up based on different base, intermediate and/or end nodes. When the protection LSPs have been set up, program flow may terminate in a state 618.

The alternate LSPs (e.g., paths 702-708) set up in steps 602-618 are explicitly routed paths and, because they preferably extend at least two hops, they “prune out” intermediate nodes (e.g., the node 124) through which adjacency is learned. Note that while a protection LSP preferably provides an alternate route around one intermediate node, the alternate LSP can include any number of hops.

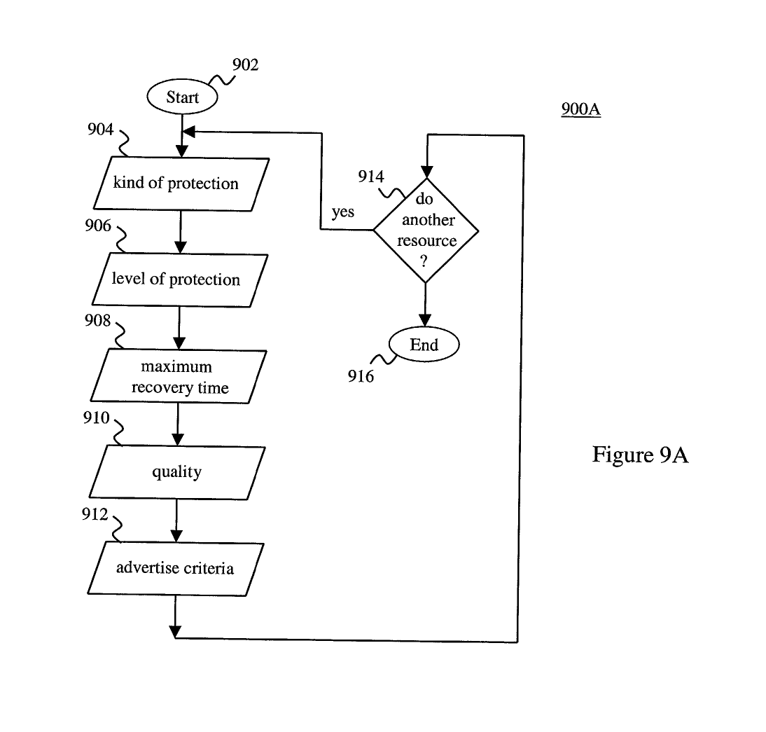

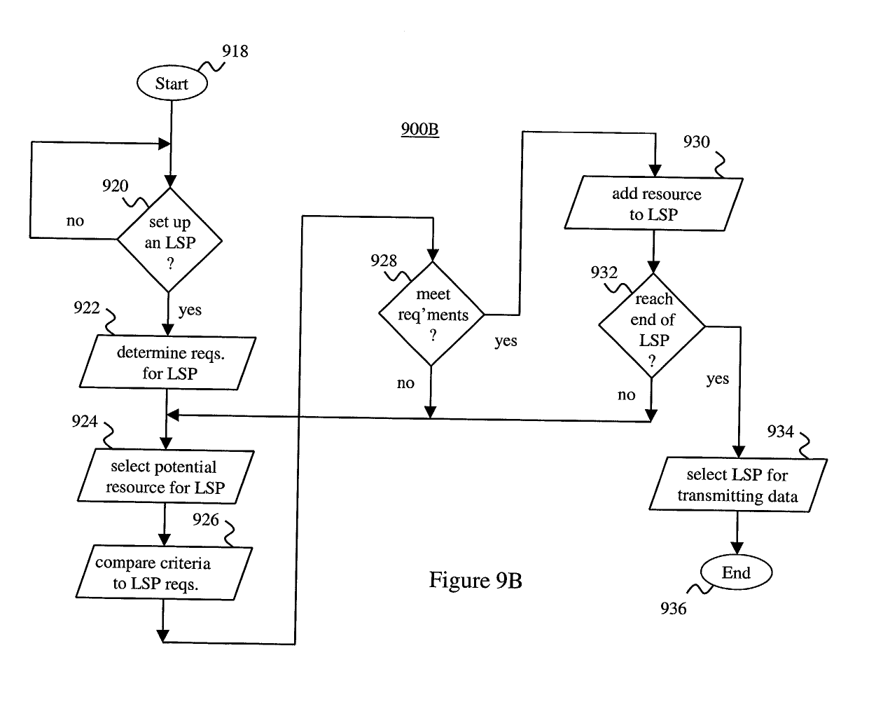

Then, when an LSP is desired to be set up that is to be protected by the protection LSPs, program flow may begin again in state 620 (FIG. 6B). Program flow moves from the state 620 to a state 622 in which nodes of the network 100 (FIG. 7) may set up end-to-end LSPs. An end-to-end LSP may be set up, for example, in response to a request to send data. Unlike the alternate, protection LSPs set up in the state 610, the LSPs set up in the state 622 may be protected LSPs. The protection LSPs provide protection for the protected LSPs. For example, an end-to-end LSP may be set up in the state 622 to communicate data from customer equipment 122 to customer equipment 118. In accordance with one embodiment of the invention, fast re-route may be a protection level specified from among a variety of protection levels, as explained below in reference to FIGS. 9A and 9B. This protected LSP may pass through the node 124. In addition, alternate LSPs may be selected to provide fault tolerance protection for portions of the protected LSP. Thus, assuming the protected LSP passes through the node 124, alternate LSP 702 and/or alternate LSP 704 may be selected in the state 622 for protecting the end-to-end LSP in the event of a fault in the node 124 or in one of the links coupled to the node 124.

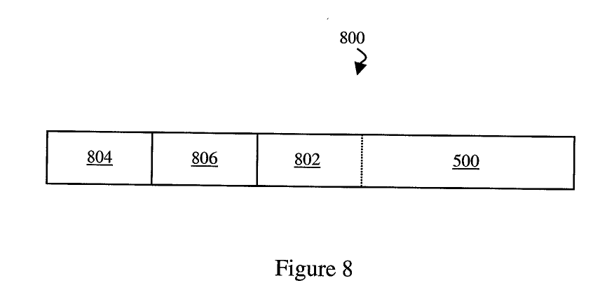

To provide support, such as in a Multi-Protocol Label Switching (MPLS) network, for the signaling required to set up and to utilize the protected LSPs and the alternate, protection LSPs, a new type-length value (TLV) may be defined. FIG. 8 illustrates a TLV 800 in accordance with the present invention. A value field of the TLV 800 may include a Shared Risk Link Group (SRLG) 500 (FIG. 5) that corresponds to a possible fault to be avoided by the protection LSP. In addition, the value field of the TLV 800 may include the next hop label 802 for the protection LSP that is to be utilized in the event that the fault identified by the SRLG occurs. For example, for RSVP, this TLV 800 may be included in PATH messages sent as a request. In RESV (reservation) messages used to form an LSP for communicating data, nodes that support this feature will recognize the TLV 800 (e.g., by recognizing the contents of its type field 804) and add the previous hop label and link SRLG to its forwarding table 312 (FIG. 3). Thus, the fast reroute technique of the invention can be implemented between any two nodes having this support. If this feature is not supported by a network element, the TLV 800 may be passed unchanged in PATH and RESV messages. The TLV 800 may also include a length field 806 to indicate its length.

From the state 622, program flow moves to a state 624 where a determination is made as to whether a fault has occurred somewhere in the network 100. For example, a router in the network 100 (FIGS. 1 and 7) may detect a fault through its internal circuitry. Alternately, a node may detect a failure of an associated link by an absence of data received from the link or by a link layer mechanism. Program flow may remain in the state 620 until a fault occurs.

When a fault occurs, program flow may move to a state 626. In the state 626, a notification of the fault identified in the state 624 may be made. For example, the fault notification technique described herein with reference to FIG. 4 may be utilized in the state 626 to propagate the notification to affected components in the network 100. In which case, the nodes of the network 100 (FIGS. 1 and 7) may receive a fault notification that includes the SRLG associated with the failure. Other fault notification techniques may be used.

Program flow may then move from the state 626 to a state 628. In the state 628, data traversing a protected LSP that is experiencing the fault identified in the notification received in the state 626 may be re-routed via one of the protection LSPs so to avoid the fault. Each node may then determine whether the fault affects its applications (e.g., LSPs or IGP communications that the node is using). For example, the fault manager 336 (FIG. 3) of each node may then look up the SRLG its forwarding table 312 (FIG. 3) to determine whether any LSPs associated with the node are affected by the fault. If so, then the next hop label 802 (FIG. 8) identified based on the SRLG may be substituted and used as the appropriate label for the next hop for the appropriate protection LSP that corresponds to the SRLG. Accordingly, the protected LSP is reformed using the protection LSP to avoid the fault. Program flow for the identified fault may terminate in the state 630.

In this manner, fast re-routing via predetermined protection LSPs may be implemented so as to avoid entire nodes.

Another aspect of the invention is a system and method for providing multiple levels of fault protection in a label-switched network. The invention provides an improved technique for managing available types of redundancy to provide a minimum specified amount of protection for various data flows without wasting resources, such as by providing excessive redundancy.

FIGS. 9A-B illustrate a flow diagrams 900A-B for managing multiple levels of fault protection in accordance with the present invention. As explained in more detail herein, the flow diagrams 900A-B may be implemented by the network 100 illustrated in FIG. 1 and by elements of the network 100, such as the router 300 illustrated in FIG. 3. For example, the distributed network manager implemented by the network management modules 340 (FIG. 3) of each node may coordinate actions of the nodes in the network 100 to implement the steps of FIGS. 9A-B.

In one aspect of the invention, protection criteria for various network resources may be specified. This provides a uniform scheme for classifying and comparing types and levels of redundancy and fault protection techniques. The criteria may include, for example: a kind of protection; a level of protection; a maximum recovery time; and a quality of backup path. For example, classification may be performed under control of the distributed network manager.

Referring to FIG. 9A, program flow begins in a start state 902. From the state 902, program flow moves to a state 904. In the state 904, a kind, type or category of protected resource may be specified for a particular resource of the network 100 (FIG. 1). For example, the protected resource may be a complete end-to-end label-switched path (LSP) within the network 100. Alternately, the protected resource may be a portion of the network 100, such as a series of links and nodes that form a multiple-hop path segment. Further, the protected resource may be a single network element (e.g., a node or a link) or a specified portion of a network element (e.g., an individual card slot of a router). The criteria specified in the state 904 may then be associated with an identification of the particular resource to which it pertains. For example, if the type of resource is a single node, then indicia of the type “node” may be associated with an identification of a particular one of the nodes the network, such its MAC address.

Then, program flow moves to a state 906 in which a level or type of protection criteria for the resource identified in the state 904 may be specified. This criteria may, for example, specify a level of redundancy available to the resource. The level or kind of criteria specified in the state 906 will generally result from the topology of the network and from characteristics of individual network elements. For example, the protection provided may be 1:1, 1:n, 1+1, ring, or fast re-route. Fast re-route may be as explained above in reference to FIGS. 6-8 or another fast re-routing technique. Further, these criteria may be further specified according to classes and sub-classes of protection. For example, 1:1 protection may be considered a special case of 1:n protection that provides a higher level of fault tolerance than other 1:n levels.

Nodes of the network may include a number of card slots that accept port circuitry. Thus, a point of failure may be the circuitry or connector associated with any of the card slots. In one embodiment, the router includes sixteen card slots, one for each of sixteen port circuitry cards. In addition, each router may be coupled to a number of network links. Thus, a point of failure may be any of the network links. In one embodiment, each port circuitry card includes circuitry for sixteen input/output port pairs. Thus, in the case of a router having one two-way network link for each input/output port, the router may be coupled to up to 1024 network links. Thus, there need not be a one-to-one correspondence of links to input/output pairs, such as to provide redundant links for an input output pair or to provide redundant input/output pairs for a link.

Accordingly, redundant port hardware (i.e. “slot-level”) protection may be specified. By using slot-level protection, an available card slot or port circuitry card may take over the functions of a failed slot or card. This type of protection tends to be costly, however, in that an entire spare card slot may be required as a backup even if only one port in the slot or card fails. Thus, in accordance with the present invention, in the event of a failure of fewer than all of the ports associated with a slot, a type of redundancy other than slot-level protection may be provided for recovery, such as fast re-route or ring type redundancy. Because a conventional router may utilize an add-drop multiplexer that effectively isolates the router from other portions of the network, such a router would not generally be able to employ types of protection other than slot-level redundancy, such as ring type redundancy, to recover from the failure of circuitry for a single port. This slot-level protection provides increased flexibility for selection of various forms of protection for recovery from various faults.

From the state 906, program flow may move to a state 908, in which a recovery time criteria may be specified. The recovery time criteria may be a maximum amount of time necessary to restore traffic carried by the protected resource. This time period may be measured from the occurrence of the fault or the detection of the fault. As another example, a maximum recovery time may be specified for a network link. More particularly, a network link with fast re-route protection may require a certain amount of time to recover from a fault that affects that link. If this fast re-route recovery time exceeds the maximum recovery time tolerable for an LSP that uses that link, this may indicate that an alternate protection technique is required for the LSP.

Program flow may then move to a state 910 in which the quality of backup path criteria may be specified. This may include, for example, transmission characteristics of a back-up path. For example, in the event that traffic needs to be re-routed via a backup, protection path to avoid a fault, the backup path may need to have a bandwidth that is equal to (or greater than) the protected path. In which case, the quality of the backup path would be specified as commensurate with the original, protected path. Alternately, some degradation in performance may be tolerable until the original path is restored. In which case, the backup path may be specified to have a lower quality. For example, the backup path may have a lower bandwidth than the original, protected path. The quality criteria may include criteria other than bandwidth, such as latency or mean time between errors (MTBE).

From the state 910, program flow may move to a state 912. In the state 912, the protection criteria specified in the states 904-910 may be transmitted throughout the network 100 (FIG. 1) along with the identification of the network resource to which it pertains. For example, a network element (e.g., a node) may communicate the protection criteria made available to it to the other elements in the network 100. This may be accomplished, for example, by the network element sending link state attribute (LSA) advertisements. Each node may then store the advertised fault protection criteria in its local memory.

Then, in a state 914, a determination may be made as to whether to specify protection criteria for another network resource. This may be performed under control of the distributed network manager. If the determination is affirmative, program flow may return to the state 904 and the process of specifying and advertising the criteria may be repeated for the next network resource.

Program flow may terminate in a state 916. Thus, in states 904-914, protection criteria that are inherent in the network are identified for any number of components of the network. This protection criteria may be stored throughout the network 100 as a distributed database. For example, these criteria may be a result of the topology of the network and the characteristics of individual network elements. Once protection criteria has been specified for the network resources and advertised, the criteria may then be used when a network element sets up an LSP to send data. More particularly, the protection criteria desired for the LSP may be compared to the criteria inherently available in the network in order to set up the LSP in such a way as to ensure that LSP receives the desired level of protection.

Accordingly, program flow may begin again in a state 918 (FIG. 9B) and then move from the state 918 to a state 920 in which a determination is made as to whether to set up a protected end-to-end LSP. Then, in a state 922, the network element or node setting up the LSP may determine protection requirements for the LSP. For example, a sender of data (e.g., an application program or a user) may specify the protection criteria to be utilized for sending the data.

Program flow may then move from the state 922 to a state 924. In the state 924, the node setting up the LSP (i.e. a source node) may select a potential resource to be utilized by the LSP being set up. Then, program flow moves to a state 926 in which the node setting up the LSP may then compare the criteria received from the other network elements (in the state 912) that pertains the resources to be utilized for this candidate resource to its own requirements (obtained in the state 922) for the LSP. This comparison may determine whether the candidate LSP selected in the state 924 will meet the protection requirements specified for the LSP.

For example, the amount of recovery time that an LSP will be able to tolerate will generally depend upon the nature of the data carried by the LSP. For example, an LSP used for transferring data files between computer systems at nodes of the network 100 (FIG. 1) will generally have a longer tolerable recovery time than would an LSP used for carrying real-time video or audio information. If the specified time is exceeded, the LSP may be declared down, in which case, traffic over the LSP may be halted unless another suitable path is found. Accordingly, so that the maximum recovery time is not exceeded, the recovery time for each candidate resource for the LSP will need to be less than the maximum tolerable for the type of data to be sent via the LSP.

Then, program flow may move to a state 928 in which a determination may be made as to whether the protection criteria meets the requirements for the LSP. For example, if the source node for the data determines that the recovery time for candidate resource exceeds the maximum, then another candidate resource will need to be selected. As another example, if a network resource to be used by the LSP does not have sufficient fault protection, additional protection may need to be added for that resource or an alternate resource selected that does have sufficient protection. Thus, program flow may return to the state 924 in which another potential resource for the LSP may be selected.

Assuming protection criteria for a resource meets the requirements for the LSP, then program flow moves to a state 930 in which the resource may be incorporated into the LSP. Then, in a state 932, a determination may be made as to whether sufficient resources have been added to complete the LSP. If not, program flow may return to the state 924. Thus, new candidate resources may be repeatedly selected and added to the LSP (or rejected) in the states 924-932.

Note that if after a predetermined number of tries, no candidate resources are available that meet the requirements, modifications to the network 100 may be required. In which case, this condition may be advertised and appropriate steps taken. For example, the distributed network manager may direct a node to be reconfigured to provide an additional physical card slot to provide redundancy for a particular interface of the node. Alternately, a network administrator may need to install additional links between pairs of nodes in the network 100 (FIG. 1).

Once an entire LSP has been constructed from then selected resources, program flow may move to a state 934 in which the LSP is selected for sending the data. Program flow may then terminate in a state 936.

Thus, an improved technique for managing available types of redundancy to provide a minimum specified amount of protection for various data flows without wasting resources, such as by providing excessive redundancy, has been described.

While the foregoing has been with reference to particular embodiments of the invention, it will be appreciated by those skilled in the art that changes in these embodiments may be made without departing from the principles and spirit of the invention, the scope of which is defined by the appended claims.

What is claimed is:

1. A method of managing multiple levels of fault protection in a data communication network, comprising:
storing in the network fault protection criteria for each of a plurality of resources in the network, including a type of fault protection available to the resource;
determining desired fault protection criteria for a communication path between a node of the network that is a source for data and a node of the network that is a destination for the data;
selecting a candidate resource of the network for the communication path; and
determining from the fault protection criteria for the candidate resource whether the candidate resource provides at least the desired level of fault protection and when the candidate resource provides at least the desired level of fault protection, selecting the candidate resource for the communication path.

2. The method according to claim 1, wherein the communication path is a label switched path (LSP).

3. The method according to claim 1, further comprising selecting another candidate resource when the candidate resource does not provide at least the desired level of fault protection.

4. The method according to claim 1, further comprising modifying the network to provide another candidate resource that does provide at least the desired level of fault protection when the candidate resource does not provide at least the desired level of fault protection.

5. The method according to claim 1, wherein the fault protection criteria for each of the plurality of resources includes indicia of a type of the resource.

6. The method according to claim 5, wherein the type of the resource includes a multiple-hop path segment.

7. The method according to claim 5, wherein the type of the resource includes a single network node.

8. The method according to claim 5, wherein the type of the resource includes a single network link.

9. The method according to claim 1, wherein the type of fault protection available to the resource includes 1:n protection.

10. The method according to claim 9, wherein the type of fault protection available to the resource includes 1:1 protection.

11. The method according to claim 10, wherein the type of fault protection available to the resource includes ring protection.

12. The method according to claim 1, wherein the type of fault protection available to the resource includes a fast re-route technique.

13. The method according to claim 1, wherein the type of fault protection available to the resource includes slot-level protection.

14. The method according to claim 13, wherein when less than all of ports associated with a particular slot fails, a type of fault protection other than slot-level protection is available for recovery.

15. The method according to claim 1, wherein the fault protection criteria for each of the plurality of resources includes indicia of a recovery time for the resource.

16. The method according to claim 15, wherein said determining comprises comparing the indicia of the recovery time for the certain ones of the resources of the network to a maximum desired recovery time for the path between the source and the destination.

17. The method according to claim 1, wherein the fault protection criteria for each of the plurality of resources includes indicia of characteristics of a back-up path for the resource.

18. The method according to claim 17, wherein the characteristics of the back-up path include indicia of its quality.

19. A method of managing multiple levels of fault protection in a data communication network, comprising:
advertising within a network fault protection criteria for each of a plurality of resources of the network;
determining desired fault protection criteria for a communication path between a node of the network that is a source for data and a node of the network that is a destination for the data;
selecting a candidate resource in the network for the communication path; and
determining from the advertised fault protection criteria for the candidate resource whether the candidate resource provides at least the desired level of fault protection and when the candidate resource provides at least the desired level of fault protection, selecting the candidate resource for the communication path.

20. The method according to claim 19, the communication path being a label switched path.

21. The method according to claim 19, further comprising a step of specifying the fault protection criteria prior to said advertising, said step of specifying being performed under control of a distributed network manager implemented by each of the plurality of nodes of the network.

22. The method according to claim 20, said selecting being performed by the node that is the source for the data.

23. The method according to claim 20, further comprising selecting another candidate resource when the candidate resource does not provide at least the desired level of fault protection.

24. The method according to claim 20, further comprising modifying the network to provide another candidate resource that does provide at least the desired level of fault protection when the candidate resource does not provide at least the desired level of fault protection.

25. The method according to claim 1, wherein the fault protection criteria for each of the plurality of resources includes a type of the resource.

26. The method according to claim 25, wherein the type of one or more of the resources includes a multiple-hop path segment.

27. The method according to claim 25, wherein the type of one or more of the resources includes a single network node.

28. The method according to claim 25, wherein the type of one or more of the resources includes a single network link.

29. The method according to claim 24, wherein the fault protection criteria for each of the plurality of resources includes a type of fault protection available to the resource.

30. The method according to claim 29, wherein the type of fault protection available to one or more of the resources includes 1:n protection.

31. The method according to claim 29, wherein the type of fault protection available to one or more of the resources includes 1:1 protection.

32. The method according to claim 29, wherein the type of fault protection available to one or more of the resources includes ring protection.

33. The method according to claim 29, wherein the type of fault protection available to one or more of the resources includes a fast re-route technique.

34. The method according to claim 29, wherein the type of fault protection available to one or more of the resources includes slot-level protection.

35. The method according to claim 34, wherein when less than all ports associated with a particular slot fails, a type of fault protection other than slot-level protection is available for recovery.

36. The method according to claim 24, wherein the fault protection criteria for each of the plurality of resources includes indicia of a recovery time for the resource.

37. The method according to claim 36, wherein said determining comprises comparing the indicia of the recovery time for the certain ones of the resources of the network to a maximum desired recovery time for the path between the source and the destination.

38. The method according to claim 24, wherein the fault protection criteria for each of the plurality of resources includes indicia of characteristics of a back-up path for the resource.

39. The method according to claim 38, wherein the characteristics of the back-up path include indicia of its quality.

40. A system for managing multiple levels of fault protection in a data communication network, comprising:
a plurality of resources in a network, each having a specified fault protection criteria that includes indicia of a type of fault protection available to the resource; and
a plurality of candidate resources in the network for a communication path between a node of the network that is a source for data and a node of the network that is a destination for the data, wherein the source node determines from the fault protection criteria for the plurality of candidate resources whether the candidate resources provide at least the desired level of fault protection and, when candidate resource provides at least the desired level of fault protection, the source node selects the candidate resource for the path.

41. The system according to claim 40, wherein the fault protection criteria is advertised to a plurality of nodes in the network.

42. The system according to claim 40, wherein the fault protection criteria for each of the plurality of resources includes indicia of a type of the resource.

43. The system according to claim 40, wherein the type of fault protection available to one or more of the resources includes slot-level protection.

44. The system according to claim 43, wherein when less than all ports associated with a particular slot fails, a type of fault protection other than slot-level protection is available for recovery.

45. The system according to claim 40, wherein the fault protection criteria for each of the plurality of resources includes indicia of a recovery time for the resource.

46. The system according to claim 45, wherein the source node compares the indicia of the recovery time for the certain ones of the resources of the network to a maximum desired recovery time for the path between the source and the destination.

47. The system according to claim 40, wherein the fault protection criteria for each of the plurality of resources includes indicia of characteristics of a back-up path for the resource.

48. The system according to claim 47, wherein the characteristics of the back-up path include indicia of its quality.
